(19) United States
(12) Patent Application Publication
(10) Pub. No.: US 2005/0149401 A1
(43) Pub. Date: Jul. 7, 2005

(54) System and method for an intellectual property collaboration network

(76) Inventors: Paul Louis Ratcliffe, Ashburn, VA (US); Cory Jon Sorice, Towson, MD (US)

Correspondence Address: Paul L. Ratcliffe, 42870 Meander Crossing Court, Ashburn, VA, 20148, US

(21) Appl. No.: 11/029,374

(22) Filed: Jan. 6, 2005

Related U.S. Application Data
(60) Provisional application No. 60/534,637, filed on Jan. 7, 2004.
(60) Provisional application No. 60/572,493, filed on May 20, 2004.

(51) Int. Cl. G06F 17/60

(52) U.S. Cl. 705/14

(57) ABSTRACT

The present invention provides a system and method for providing an intellectual property collaboration network for the development and improvement of inventions and technology with inventors being granted equity or an ownership interest in patent arrays or companies which patent, market, license and generate revenue from the developed technology. The present invention provides a unique way of distributing equity to contributing inventors of ideas and owners of patents within the network for those technologies which are grouped and related. The system of the present invention enables inventors to submit ideas, collaborate on projects, advance technology and protect inventions through an intellectual property network which provides inventors equity in companies or patent arrays in exchange for the developments which are then patented, marketed, and licensed with revenue flowing through the companies and patent arrays back to the inventors and other contributors of the system. The system may also be used for existing and donated patents which can be marketed and licensed through the system including granting equity or ownership interest in the patent arrays or companies to owners of the existing or donated patents.

The present application claims priority from U.S. Provisional Patent Application No. 60/534,637 filed on Jan. 6, 2004 and U.S. Provisional Patent Application No. 60/572,493 filed on May 20, 2004 both of which are incorporated herein by reference in their entirety.

### FIELD OF THE INVENTION

The present invention relates to a system and method for promoting, marketing, licensing, developing and supporting ideas, inventions and technology development through a collaborative intellectual property network.

### BACKGROUND OF THE INVENTION

Intellectual property has proven to be and continues to be looked upon as a vital asset and focus of companies, universities, organizations and individuals. The number of patent applications filed each year in the United States continues to increase and many companies are expending considerable efforts and resources to protect and exploit their intellectual property. However, according to data provided by the United States Patent and Trademark Office (USPTO), at the same time the number of patent filings are increasing the percentage of patent filings by individual inventors is decreasing.

There are several reasons why independent inventors, and small universities and companies, are losing ground to large companies. One such reason is that the process of preparing, drafting, and filing a patent application is very expensive due in part to the formalistic and complicated process. In fact, the USPTO recommends inventors hire patent attorneys or agents to assist in the patenting process. However, the fees for retaining a patent attorney or agent to prepare and prosecute a patent application through issuance can easily exceed $20,000 dollars per application. The price makes such activities cost prohibitive for most small companies, small to medium universities and individual inventors.

In addition, although many people have novel ideas, concepts, and improvements they may not have all of the technical know how to enable or reduce the idea to practice. One reason large companies are leading technological advancements is because they are able to form teams of scientists, engineers, computer programmers and others from varied disciplines to invent, improve, and develop technology. Understandably, the collaboration or combination of many minds working together facilitates and speeds the development of technology. Unfortunately, many independent inventors and smaller companies do not have the same technical breadth or resources and they are apprehensive to disclose their ideas to others for collaboration to avoid having their idea or invention stolen.

Therefore, what is needed is an intellectual property collaboration network which enables inventors, scientists, engineers, computer programmers, or anyone capable of improving or contributing to the advancement of products and technology to disclose and collaborate on ideas and to improve or advance technology. Such a system will enable users to disclose ideas, concepts, and improvements to other members of the network either as a whole or to select members or teams to collaborate on the development of the idea in exchange for compensation which could include: a fee, a share or equity interest in any profits, revenue, or royalties generated from the sale or licensing of the ideas or patents obtained on the ideas, or for equity in a patent array or portfolio, or equity in a separate company to which the idea or patent is assigned. The network may be a system, online community, or internet based network which allows users or members of the network to collaborate and interact remotely through the platform and structure of the network. By providing a network, forum, or community for inventors to collaborate and develop technology and the structure by which their individual or corporate interests (if they are working on behalf of a company) are secured through ownership in the developed intellectual property, they can develop technology knowing they will share in any returns or benefits for their contributions and inventions. In addition, the present invention provides the framework to allow the inventors to use patent and business professionals affiliated with the network to facilitate protection, marketing and licensing of the developed intellectual property.

Further, although many people have great ideas, concepts, and improvements it is unlikely that they possess all of the necessary skills, time, and money to accomplish all of the tasks necessary to maximize the revenue potential from their ideas. Oftentimes, due to early failure to find licensing opportunities, the ongoing costs to maintain patents, and the extremely expensive cost to enforce a patent through litigation, inventors and companies abandon these valuable patents.

Therefore, what is needed is a network or system which assists patent owners in realizing and maximizing the revenue from their patents and enables the patent owners to share costs, share revenue, gain access to marketing and licensing professionals and use the power of many patents (or other intellectual property) to increase the efficiency and return throughout all phases of the patent life cycle.

### SUMMARY OF INVENTION

The present invention provides a system and method for an intellectual property collaboration network for the collaboration on and development of technology, innovation, and invention and for the intellectual property protection and ownership distribution of the collaborators within the network. The system of the present invention provides a unique and novel way to create projects, find collaborators, and reward collaborators through various means including monetary means or equity interest in the created intellectual property.

The system of the present invention will allow users to search and filter the profiles of other users and contact the users best suited for collaboration on a given project. The system also provides a unique way of distributing ownership interest in or equity to the contributors (companies and individuals) associated with the developed technology and related patents, patent applications, or other intellectual property. Therefore, users of the system can work with other members of the system to invent and develop technology knowing their interest in the developments is secure, the advancements will be protected, and they will reap their portion of any revenue generated from the intellectual property.

In addition, as a means to mitigate risk and entice contributions, the system of the present invention can be utilized to group related or complimentary technology and patents into patent arrays or pools to provide companies easy access to license a particular patent, several patents, or the entire portfolio of patents in the array as a means to ease commercialization within a defined intellectual property field. An added benefit of the array approach is that even if an individual patent in the array does not warrant a license or royalties the inventor(s) of the patent in the array might still receive an equity share in the array and a portion of the royalty stream from the entire array. Such a system might entice users or contributors to continue to submit ideas and inventions knowing there is an obtainable and readily apparent financial benefit. The system can also adapt the percentage of ownership or equity distributed amongst the various patents in the array to account for more valuable patents and can split equity between various inventors which contributed on each patent in the array. The present invention provides system, method and structure for an intellectual property collaboration network and community which promotes collaboration amongst the technical community in exchange for ownership, equity, or a share of any monetary benefit gained from the sale or license of the developed technology and related intellectual property.

Further, the present invention provides a system which allows inventors to diversify their efforts by working on multiple projects in different technology areas. This provides the benefit that a particular contributor will not have all of their equity tied to one patent or type of technology, one patent array or one company enabling the inventor or collaborator to diversify their holdings.

In addition, the system will allow companies and universities to work through the system of the present invention to suggest projects, pay for or invest in the development of projects or technology, and license technology or intellectual property through the intellectual property collaboration network.

The present invention also provides a system and method which overcomes the known obstacles and problems with inventing, patenting, and commercialization by providing a system which encourages inventor collaboration through an intellectual property network which protects the ideas and technology created while promoting user interaction through user defined compensation or equity sharing of the created intellectual property and its financial output.

The present invention also provides a system and method for a cost and revenue sharing intellectual property network for maximizing revenue from intellectual property while creating a cost efficient process. In one embodiment, the network receives or obtains patents, or other intellectual property, in various ways and groups the patents into related technology arrays. Equity or shares in the array or in a company holding the array might be distributed amongst: (1) the patent owners, inventors and collaborators; (2) the company managing and running the network; (3) and any other contributors such as attorneys and business professionals assisting or providing services to the patents.

The present invention also provides a unique way for companies and individuals to donate their intellectual property, primarily patents, to a charitable organization in return for a tax deduction. The charitable organization can then utilize the intellectual property network of the present invention for increasing potential revenues or proceeds generated from the donated patents.

The present invention also helps to mitigate risk and entice contributions, even if only at a cost basis, since complimentary technology and patents will be grouped in patent arrays or pools which will allow the knowledge learned from marketing one patent to be reused or leveraged across the entire array or pool. In addition, even if an individual patent in the array has not been licensed the inventors or contributors of the patent in the array might still receive an equity share in the array or company holding the array and therefore a portion of the royalty stream from the array.

The system can also adapt the percentage of equity distributed amongst the various patents in the array to account for more valuable patents and can split equity between various inventors which contributed on each patent in the array. In one embodiment it is envisioned that ten percent (10%) of all the revenue generated from all patents in the array will be split equally amongst all patents in the array with the remaining revenue being distributed to those specific patents which generated the revenue according to the percentage of revenue each patent in the array garnered.

The present invention also provides a method, system, and structure for a cost and revenue sharing intellectual property network which promotes the combination of grouping or pooling of many patents and ideas which are converted into patents into a network through various means and then using the power of many patents to create an efficient, lower cost intellectual property network which can maximize revenue from the grouped intellectual property.

### BRIEF DESCRIPTION OF DRAWINGS

FIG. 1 is a system diagram of the preferred embodiment of the intellectual property collaboration network of the present invention.

FIG. 2 is a system diagram of an exemplary embodiment of the present invention enabling equity distribution to inventors.

FIG. 3 illustrates exemplary content available to a user of the online or website based collaboration network.

FIG. 4A is a flow chart showing a flow of operation of an exemplary embodiment of the present invention.

FIG. 4B is a flow chart showing a flow of operation of an exemplary embodiment of the present invention.

FIG. 4C is a flow chart showing a flow of operation of an exemplary embodiment of the present invention.

FIG. 4D is a flow chart showing a flow of operation of an exemplary embodiment of the present invention.

FIG. 4E is a flow chart showing a flow of operation of an exemplary embodiment of the present invention.

FIG. 5 is a block diagram of the computer system of an exemplary embodiment of the present invention

FIG. 6 is a system diagram of a further exemplary embodiment of the present invention.

### DETAILED DESCRIPTION

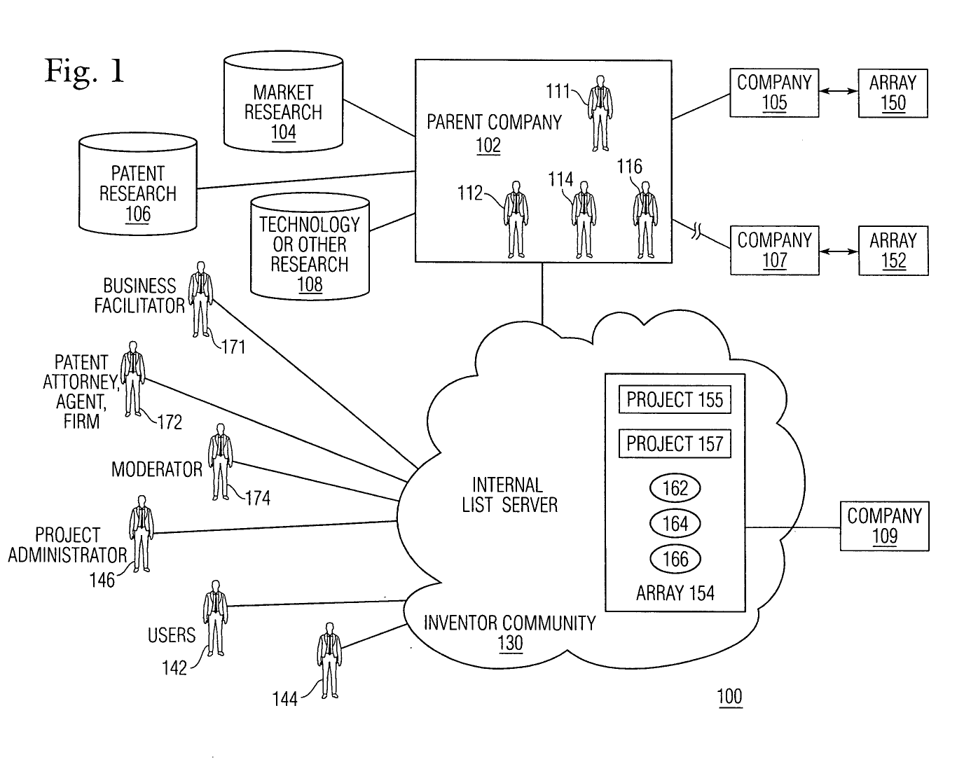

The present invention will now be described in conjunction with FIGS. 1-6 and reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiment may be utilized and that logical changes may be made without departing from the spirit and scope of the present invention. The following detailed description is, therefore, not to be taken in a limiting sense, and the scope of the present invention is defined by the appended claims.

The following detailed description is divided into four sections. In the first section, a first preferred computerized embodiment of the present invention is described. In this system and method, a computer system enables users to create and establish projects through an online network and seek collaboration from other users for the development of the project. The system enables collaborators to be identified through search functions of user profiles and attributes to select those users best suited for collaboration on a particular project and to contractually determine the ownership interest amongst the collaborating users of any developments. In the second section, the process for using the preferred embodiment of the present invention will be described. In this section the method and process steps by which a user interacts with the system of the present invention from idea or project creation to cash distribution will be described. In the third section, an exemplary embodiment of the system architecture in which the preferred methods of the invention may be practiced is described. This exemplary system architecture includes various computer systems for hosting and managing an internet network, databases, accounting means, and the interface of users and collaborators. Finally, in the fourth section, an exemplary embodiment of the present invention is described which provides a method for an intellectual property network which enables intellectual property from sources outside of a computer network to utilize the present invention.

Section 1: A First Preferred Computerized Method and System of the Invention

The preferred embodiment of the present invention will now be described in conjunction with FIGS. 1-3. The present invention overcomes the known obstacles of collaboration, inventing and patenting by providing an intellectual property network, system, and method which enables inventors to submit inventions and ideas, collaborate on inventions and projects with other users (scientists, engineers, programmers, designers, and anyone that can contribute) to invent, develop, innovate, design, and improve technology while establishing interest in revenue streams generated from the developments.

As seen in FIG. 1, the system 100 of the present invention includes several components which include: (1) the parent company or organization 102 including related systems, databases and information 104, 106, 108; (2) the network, website, online or internet based inventor community 130; (3) individual users 142, 144; (4) inventors 162, 164, 166; (5) intellectual property arrays 150, 152, 154 which may or may not be housed within a company or corporate entity 105, 107; and (6) other individuals capable of participating 146, 171, 172, 174.

In a preferred embodiment, a parent company 102 operates and manages the intellectual property collaboration network 100 which is operated through an online website community 130. The company 102 may manage the resulting patents and patent applications, intellectual property, patent arrays 150, 152, 154, users 142, 144, inventors 162, 164, 166, project administrators 146, array or technology moderators 174, and patent attorneys or agents 172. In addition, the company 102 may have employees such as business facilitators 111, patent attorneys or agents 112, technology moderators 114, or project administrators 116. The company 102 may also research market data 104, patent data 106, and other data 108, such as consumer data, technology information, technology trends and so forth. Ultimately, the parent company 102 or a separate company 105, 107 may market, sell, license, and capitalize on the patents and other intellectual property which are licensed into, owned or brokered by or placed in the arrays 150, 152, 154.

The inventor community 130 may be in the form of any medium or platform which supports large scale communication and information exchange amongst a large group of users. The preferred embodiment will be an online website based community or network 130. The online network 130 will enable users 142, 144 to register, participate in and collaborate on the development of various projects or technology with other users 142, 144 or submit invention and idea disclosures for patent filings. The ideas, improvements and developments may be converted into patent applications and patents which can be licensed into, brokered by, or owned by the parent company 102, an affiliated company 105, or an unaffiliated company 107 in exchange for compensation, such as equity in the company 102, 105, 107 capitalizing on the patent, or equity in an array of patents or other intellectual property assets. Once a user 142, 144 has created a project through the online network 130, the user becomes the project administrator 146 for that project and guides the project through the collaboration process.

The individual users 142, 144, 146 and inventors 162, 164, 166 of the system may collaborate to enhance and speed the development of technology and projects with the goal of securing the intellectual property assets behind the technology, securing each contributors interest in the intellectual property, and seeking royalties or other potential monetary benefits from those assets. The users 142, 144, 146 and inventors 162, 164, 166 collaborate and advance their projects through the dissemination of information, collaboration, and the knowledge and efforts of a wide group of users 111, 112, 114, 116, 142, 144, 146, 162, 164, 166, 171, 172, 174 facilitated through the community 130.

Once a user 142, 144, 146 has created a project 155, 157 or agreed to contribute or collaborate on an existing project 155, 157 or has submitted a disclosure to the company 102, community 130, or a moderator 114, 174 the project 155, 157 and disclosure will be reviewed and approved. If approved, the appropriate network members, such as patent professionals 112, 172, will begin the process of protecting the intellectual asset by filing patent applications or other appropriate actions and the users will be identified as an inventor 162, 164, 166. The inventor may then be given a monetary award or equity or shares in an array 150, 152, 154 or equity or shares in a company 102, 105, 107, 109 for the license, submission, brokering rights, or assignment of the patent or intellectual property.

In the preferred embodiment, it is anticipated that patents and patent applications which are related in technology will be grouped together in Intellectual Property (IP) arrays 150, 152, 154 to enhance licensing or sale opportunities of the IP arrays 150, 152, 154 to a Company 109. The arrays 150, 152, 154 are beneficial because as a group they provide a license to complimentary technologies. However, the patents do not have to be put into arrays to interact or benefit from the system 100 of the present invention. One or more patents or other intellectual assets of an invention or development could stand by themselves or be the sole asset in an array or entity which is still licensed or sold through the network 100 to a Company 109.

In addition, other members of the community or online network 130 may include business facilitators 171, independent patent attorneys, agents, or firms 172, and moderators 174. Through inclusion or incorporation of patent attorneys, agents, or firms 172 within the system 100 or network 130 the companies 102, 105, 107, 109 and inventors 162, 164, 166 can create enough volume and efficiencies to reduce the cost of the patent services and/or offset costs by providing the patent professionals 172 equity in the associated arrays 150, 152, 154 or companies 102, 105, 107, 109 in exchange for fees related to the preparation, prosecution, licensing and enforcement of the patents in the IP arrays 150, 152, 154.

The parent company 102 or participating companies 105, 107 may also employ business facilitators 111, patent professionals 112, moderators 114, or administrators 116 or hire outside law firms 172 to assist in the preparation, prosecution, licensing and enforcement of the assets or patents in the IP arrays 150, 152, 154. The parent company 102 or the online network 130 might compile and provide access to various databases including databases on Market Research 104, Patent Research 106, or Technology or Other Research 108. The business facilitators 111, 171 may assist the moderators 114, 174 and other members of the community 130 in using the databases 104, 106, 108 to assess markets, technology, prior art, potential opportunities, licensing opportunities, and other business aspects so the projects 155, 157 are focused in need areas and provide desired revenue or solutions.

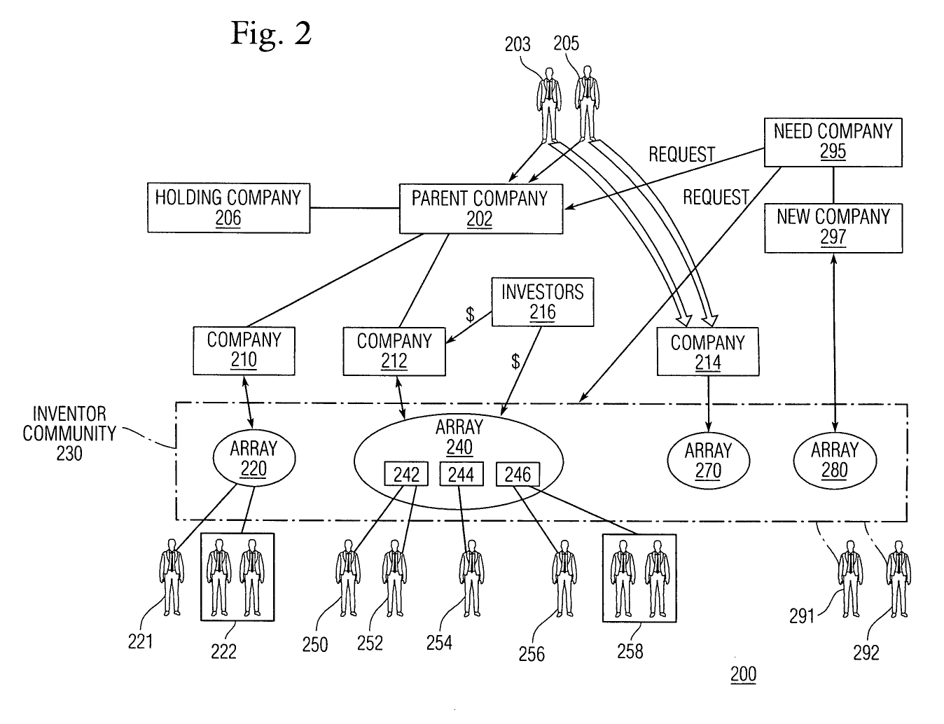

In the preferred embodiment, as will be discussed in conjunction with FIG. 2, a user 291 registers and collaborates with other users 221, 222, 250, 252, 254, 256, 258, 292 through the inventor community 230 which is managed and maintained by the parent company 202. The users 291 and 292, for example, may work on a myriad of technologies, projects and developments and may join projects, teams, groups or act alone to create or assist in the development of projects or technology. Through the community 230, the users 221, 250, 252, 254, 256, 291, 292 and project teams 222, 258 will submit disclosures for review, to seek patent protection and to seek inclusion in open arrays 220, 240, 270, 280. The parent company 202 or other companies 210, 212, 214, 295, 297 will work with the users 221, 250, 252, 254, 256, 291, 292 project teams 222, 258, patent attorneys and moderators to seek protection of the intellectual property assets.

As seen in FIG. 2, the present invention provides an adaptable structure 200 for providing equity and monetary awards to the project contributors 221, 222, 250, 252, 254, 256, 258. The structure 200 may consist of a parent company 202, affiliated companies 210, 212, unaffiliated companies 214, holding companies 206, companies in need of new technology 295 and unaffiliated new companies 297. In the preferred embodiment, companies 210, 212, or 214 may be incorporated by and/or funded through the Parent Company 202 or its primary investors 203, 205. As the users 221, 250, 252, 254, 256, 291, 292 of the online inventor community 230 create intellectual property the intellectual assets, primarily patents and patent applications, may be assigned, licensed, sold, owned or have its broker rights granted to the Parent Company 202, a holding company 206, or to other companies 210, 212, 214, 295, 297 by the inventors in exchange for use of the network 230 or system 200 of the present invention, assistance in the patenting and licensing process, and money or equity in one or more of the arrays 220, 240, 270, 280 or companies 202, 206, 210, 212, 214, 295, 297. In one embodiment, the parent company 202 or holding company 206 will own the intellectual property and grant a license to the other companies 210, 212, 214, to enable the companies 210, 212, 214 to license, sell, or capitalize on the intellectual property.

In addition, it is anticipated that investors (individual investors, groups of investors, companies or the like) 216 may fund the formation of the companies 210, 212, 214 which will own and fund the patents and the patent and licensing process or fund the arrays 220, 240, 270, 280 directly in exchange for equity in the arrays 220, 240, 270, 280 or companies 210, 212, 214. Further, the system will enable existing companies that have a certain or desired technology need (Need Co. 295) to work through the Parent Company 202 or the Inventor Community 230 to establish or advance technology or build an IP array 220, 240, 270, 280 to meet their intended technology need. In addition, a new company (New Co. 297) could be established and seek to build an IP portfolio through the parent company 202 or directly through the inventor community 230. New Co. 297 is ideally suited for potential new products or technology where the intellectual property held in the array might be better served to make and sell products or goods as opposed to being earmarked for licensing to existing companies.

By way of example, users 250 and 252 collaborate to create patent 242 which is placed into array 240 in exchange for an established number of shares in the array. Also in the array 240 is a patent 244 by inventor and user 254, and a third patent 246 which is the collaboration of a team of inventors 258 with the assistance of an individual collaborator or inventor 256. Each patent 242, 244, 246 in the array 240 is granted a certain number of shares or certain percentage of equity in the array 240 or company 212 which might own or manage the array 240. The shares allocated for each patent would then be distributed to the appropriate inventors and contributors 250, 252, 254, 256, 258 for their respective patents. In the event that the inventors 250, 252, 254, 256, 258 utilized associated patent or business professionals or worked with investors 216 the shares from their respective patents might be split amongst those providers as negotiated between the parties. Still further, the parent company 202 or array company 212 might be issued their appropriate percentage of shares for each patent in the array or the array as a whole for their activities in facilitating and managing the network, and in patenting, marketing, and licensing the array 240 and patents 242, 244, 246.

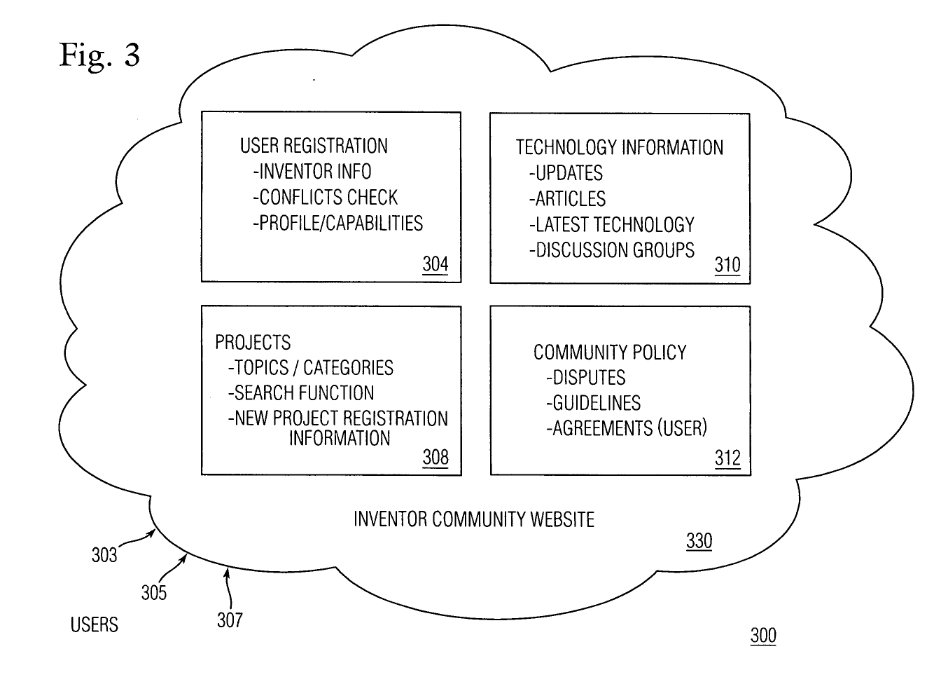

As further depicted in FIG. 3, the inventor community 300 may interact through an online website or internet platform 330 which enables user interaction. The website 330 is scalable and adaptable to meet the needs of the inventor community 300. The website 330 will enable users 303, 305, 307 to register 304 with the network 300 inventor community 330. The registration 304 process may include, but is not limited to, submission of inventor information, profile and technical capabilities, qualification for participation as a moderator or administrator, and a conflicts check.

The website 330 may list the various projects 308 or technologies being worked on by type of technology, topics, categories, products or the like. The website 330 may also include a search function to enable users 303, 305, 307 to search current projects, past projects, disclosures of the inventor community, pending patent applications of the community, issued patents of the community, issued patents and published patent applications from USPTO and other countries, existing arrays, open arrays, planned arrays, market data, consumer data, research on technology and any information deemed appropriate for the community 300. In addition, the website 330 will enable users 303, 305, 307 to submit disclosures, add new projects for collaboration, administer projects, moderate arrays, and other applicable functions to aid the inventor community 300 improve technology, seek intellectual property protection on the developed assets, and capitalize on those assets. Still further, the users will be able to identify users for collaboration on projects through the search function analyzing the profile and attributes of the registered users to find users with the appropriate background for the expertise desired.

The website 330 may also provide an education forum 310 for technological information which will provide technology updates, articles on technology, links for finding information, technology discussion groups, as well as educational or instruction material. The website 330 may also provide a community policy section 312 which provides information on how the network and inventor community 300 work, how equity distribution works, guidelines for use of the website 330 and how work and equity on the projects is distributed and administered. The community policy section 312 may also address end user agreements, contracts, guidelines, dispute resolutions, discussion on conflicts issues and any and all legal or user issues affecting the community 300. The website 330 may include any and all information needed and or beneficial to the inventor community 300 to promote the collaboration and advancement of technology and the intellectual property associated with such advancements.

Although not specifically discussed, the technology advancements and the intellectual property behind inventions may stand alone within the network, be assigned and associated as the only asset in an array or an entity (only 1 patent in one array or entity) or combined with other inventions in a group or array of patents which may or may not be associated with an entity (more than one patent in an array or entity). A further aspect of the grouped patents approach is the ability to provide companies with solutions and complimentary technology instead of barriers and hurdles. Therefore, it is anticipated that many of the disclosures, inventions and ultimately patents obtained through the community will be grouped with related, associated, or complimentary patents and technology in an array to entice companies to license portions of the array or the entire array. Each array might have its own company or entity and the inventors of each patent included in that array would be granted equity in the company aligned with that IP array.

Provided below are several examples of user involvement with the inventor community and equity and/or monetary distribution as described in conjunction with FIGS. 1-3.

### EXAMPLE 1

### An Inventor's Submission is Included in an Array

A user 142 with her own medical device invention enters the inventor community website 330. The user 142 registers via the registration interface 304 providing pertinent information and attributes needed for filing patent applications and creating a user profile. The system 100 or company 102 may conduct a conflicts check and either approves, denies, or places certain restrictions on where the user can participate to avoid employment conflicts and non-compete issues. The user 142 may search the projects and/or identified company needs or may submit her own inventions for inclusion in an array or create her own projects for submission or collaboration with other users.

In this example the user submits her medical device disclosure through the network 100 to the company 102. The company 102 receives the disclosure and either reviews the disclosure internally through its technology expert or moderator 114 or forwards the disclosure to the appropriate affiliated moderator 174 assigned to the most relevant array. In this example, the disclosure is forwarded to an independent moderator 174 who was identified as a moderator for their technical expertise in the medical device subject area. The moderator 174 acts as the technological lead in determining the best patents 162, 164, 166 for inclusion in the medical device array 154 and the most relevant projects 155, 157 for the array 154. Typically, the moderator would be granted an equity interest in the array in exchange for the technical assistance and review and a portion of any revenue generated from the array 154. The moderator 174 reviews the disclosure by user 142, determines it is a viable and worthy invention and desires to add the invention into the array 154. Since the invention does not require collaboration, the user 142 will be granted the proportional amount of equity in the array (or company 109 holding the array) related to their patent which is not obligated to the company 102 running the network and providing the patenting services or to any affiliated service providers 174.

The moderator 174 works with company 102 or 109, the patent attorney 112, 172 and the user 142 to facilitate preparation and filing of a patent application. In the preferred embodiment, the parent company 102 or the aligned company 109 may fund the filing fees, preparation, and all issue and maintenance fees associated with the patents as a means to entice broader participation. However, the system can provide for funding of the aligned company 109 or payment of associated costs by the users 142, 144 participating in the array 154 or from investors 116 funding an array for equity in the array or aligned company 109. Further, the amount of equity or shares distributed to the various inventors of the patents in the array may be determined on a case by case basis, through some calculation or ranking procedure, or any procedure which may be suitable.

In the preferred embodiment, an initial equity distribution will take place where each patent in the array is granted equal equity amounts as they are added to the array. Further, periodic adjustments, rankings, or other methods can be performed to determine which patents in the array 154 garner the most license royalties and then adjust the equity distribution amongst the equity holders accordingly. However, it is intended that patents in the arrays will always have equal equity footing but that the equity will only be used to determine the distribution among the shared revenue (i.e. 10 percent). In the preferred embodiment, the patent revenue which is not shared by all members of the array will go directly to the patent which generated the revenue and distributed according to the ownership distribution of that particular patent. In addition, a portion of the equity in the array 154 or aligned company 109 may be reserved for the parent company 102, investors 216, founding partners 203, 205, moderators 114, 174, patent attorneys 112, 172, business facilitators 111, 171, administrators 116, 176 (if they are not inventors or contributors) and/or other members of the community 130 which contributed to the development of the intellectual property 162, 164, 166 or array 154.

### EXAMPLE 2

### A User Collaborates with a Team and the Invention is Included in an Array

The second example is very similar to the first example except that the user 142 knows he needs assistance in further development of the invention or the patent attorney 112, 172 and/or moderator 114, 174 believe the invention needs further development before inclusion into an array 154. The user 142 agrees to post the invention as a project 155 on the website 330 and the user 142 becomes the administrator 146 of the project 155. As the administrator 146, user 142 can search the user profiles, solicit and select which users they want to work on the project 155. The administrator 146 can use the search tool to review user profiles to identify those users best suited to assist in developing the project 155 and either determine an appropriate equity split for this collaboration or anticipate negotiation of a fair split after communicating with prospective collaborators. Other users 144 registered with the inventor community 130 may also search projects and request to collaborate on projects 155, 157 or join teams 222, 258 who are working on technology topics in general as opposed to specific projects. In this example, user 144 is added to project 155 and provides technical or other expertise to the development process and provides a substantial and inventive contribution to the development of project 155. Finally, project 155 is concluded, submitted for approval, and a patent or other intellectual property protection is sought through the system 100 and the patent or patent application is added to the array 154.

Further, the user 142 who submits the invention is granted equity in the array 154 or aligned company 109 as is the contributing user 144. In the preferred embodiment, each patent 162, 164, 166 in the array 154 is initially granted an equal equity distribution. The company 102 would calculate and issue their shares for each patent in the network for their activities and would then provide the remaining shares to the submitter and patent contributors. For this example, the submitter (user 142) would be issued fifty percent (50%) of the remaining shares and the various project contributors would be issued the final fifty percent (50%) of shares which would be divided amongst the various project contributors. The parent company 102 or aligned array company 109 may then market, license or capitalize on the array 154 and patents 162, 164, 166 within the array 154, pay associated patent, marketing and licensing costs, and distribute the earnings or profits to the equity shareholders. A portion of all royalties into the array 154 would be split evenly amongst all patents in the array and then distributed to the appropriate equity holders for each patent. All remaining revenue would be distributed to those patents generating the revenue.

### EXAMPLE 3

### Users Collaborate and Submit a Patentable Idea Included in an Array

In the third example, several users 142, 144, and the project administrator 146 have decided to group their collective know-how to research and focus on the development of a new technology. For this example, assume that the collaborators are developing a new technology for converting audio signals into text based word applications. User 142 is a software developer with experience writing code for word or text based programs, user 144 is an engineer with experience enabling peripheral devices to communicate data, and the administrator 146 has experience creating audio translating applications. The administrator 146 started the project 157 and has agreed to form a team with users 142, 144 to invent and develop an improved audio to text based conversion application. After mush research and collaboration the team has developed a new technology for converting audio signals into text as well as the software to perform such conversion. Through the inventor community 130 they have submitted their disclosure to company 102 or a moderator 114, 174 and have been approved for moving forward on patent and other intellectual property protection. The users 142, 144, and administrator 146 work with the moderator 114, patent attorney 112, and company 102 to protect the assets.

Since the invention has vast potential as a commercialized product the intellectual assets of the project will be the sole assets placed within the array 150 or the sole asset of an aligned company 105. The assets include the software or code, any hardware designed and any patents sought on the software, hardware, or other development. The users 142, 144, and administrator 146 are each assigned equity in the aligned company 105. In an exemplary embodiment, the parent company 102 would create the affiliated company 105. The inventors will be given some equity percentage in the aligned company 105 while the parent company 102 or founding investors 203, 205 retain some equity portion of the aligned company 105. Some equity may be distributed to various other members participating such as patent attorneys 112, 172, moderators 114, 174, business facilitators 111, 171, investors 21, and/or licensing agents internal to company 102 or linked through the system 100. Once established, company 102 and/or the aligned company 105 moves forward trying to capitalize on the intellectual assets in array 150 through commercialization, licensing or sale opportunities.

### EXAMPLE 4

### Users Collaborate on an Improvement to a Technology or Product for Cash

In the fourth example, a technology based company 295 such as a wireless communications company desires the inventor community 230 to develop an improvement to existing technology which Need Co. 295 would like to license. The company 295 requests the parent company 202 to propose various projects for the community 230 and provide some patent advice to the community 230 in exchange for a flat fee, royalties, and/or a bonus. It is anticipated that companies 295 will benefit from posting desired “design around” solutions for royalties they are currently paying as a way to have the community 130 create technologies they can license at a lower rate and thereby cut costs, obtain rights to proprietary patents and access to more and/or better solutions than the currently licensed patents. The parent company 202 will develop project categories and/or identify technically capable users 221, 222, 250, 252, 254, 256, 258, 291, 292, moderators and other participants to develop, create, and manage the projects. The parent company 202 or the Need Company 295 may advertise the projects and monetary benefits to the community 230. The system 200 will then allow participants to create and submit projects and ideas for approval and approval for inclusion in the array 280 developed for Need Co. 295.

In this example, Need Co. has proposed a 1% royalty and a $100,000 bonus to the user or team which develops an invention which meets the criteria and is licensed or used by Need Co. 295. Through the community 230 an array 280 is formed and licensed to Need Co. 295. Company 295 determines that several projects or patents provide significant alternatives and that the bonus should be split amongst inventors of the array 280. Parent company 202 distributes the bonus or an equitable portion of the bonus to the inventors and other contributing members of the array and administers the array and ongoing royalties and pays the contributing members and inventors their equitable portion for the life of the license or patents.

Through the present invention a method of compensating contributors who contribute on hosted projects is provided which comprises: providing at least one server computer in communication with a computer network; hosting at least one project for collaboration through the server; providing information on the project to a plurality of users of the system; receiving a notification of a first contribution on the project and a second contribution on the project from a different user; and processing the ownership interest or some compensation for the contributing or collaborating users. The hosted project may be generated by one of the users or one of the companies or participants of the system. Further, it is anticipated that the collaborated projects will generate patents and that the contributors would be granted a percentage ownership interest in the patents or a percentage ownership in the arrays or companies managing the created patents. Revenue generated from the generated patents would then be distributed to the contributors based upon their percentage ownership interest in each patent and/or the patent arrays or companies managing the patent or arrays. The compensation might also be cash or some other product or service payment. Still further, the present invention can identify the contributors by searching stored user information performed by or in association with the server.

The present invention also provides a system for compensating users for their contributions on hosted projects. The system of the present invention comprises: at least one server computer hosting a collaboration network accessible via a computer network by at least one computer wherein the collaboration network includes at least one hosted project for collaboration; a user interface provided through the server which includes a project search function which enables the user to conduct a project search; a first computer application for searching and displaying the hosted projects; a second computer application for enabling user to submit contributions through the server computer; a third computer application for processing the receipt and notification of the contributions; and a fourth application for processing a compensation the contributing users. The system also includes user interface and computer application means for user interaction to generate the hosted projects. The system will result in the generation of at least one if not many patents with corresponding compensation to the inventors provided in the form of a percentage ownership interest in the patent or in the array or company managing or holding the patent. Further, the system includes a search application for searching the profiles of users.

In addition, the present invention provides a further method of collaborating on a hosted project comprising the steps of: providing a web site hosted by at least one computer in communication with a computer network; storing a set of information about a plurality of users through the web site; hosting at least one project for collaboration on the web site; providing information on the projects to users of the network through the web site; searching the user profiles in response to a search request and displaying the results, processing a contact request to contact other users from the user search results to collaborate on a projects through the web site; and receiving notification of the user's contributions. The present invention further intends that the projects will result in patents and that the contributors will be compensated for their contributions. The compensation may be cash or some percentage ownership interest in the patent or a patent array or a company managing or controlling the patent with revenue from the patent flowing back to the contributors based upon the their percentage ownership interest in the patent or patent array.

Section 2: An Exemplary Computerized Method of the Invention

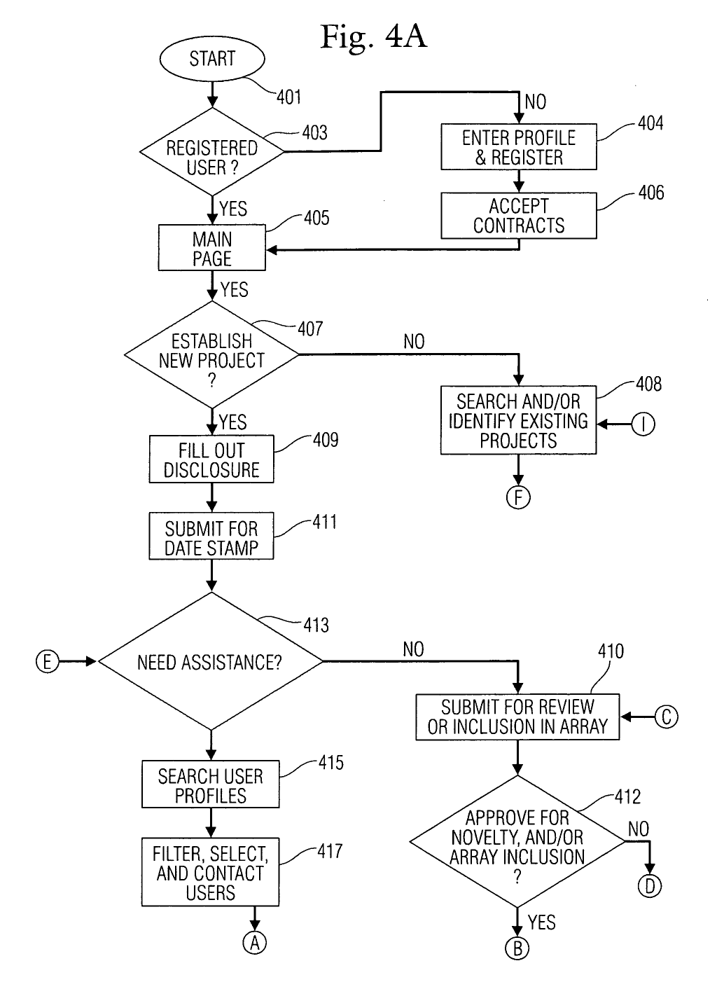

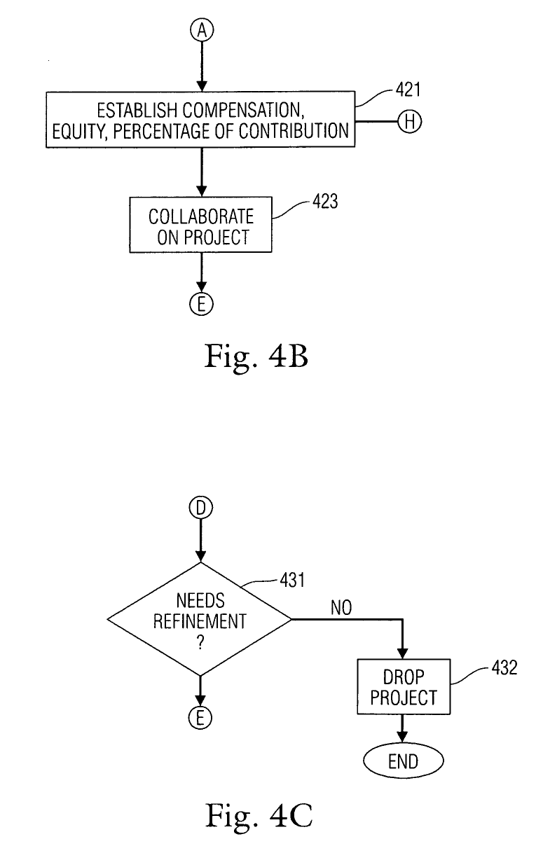

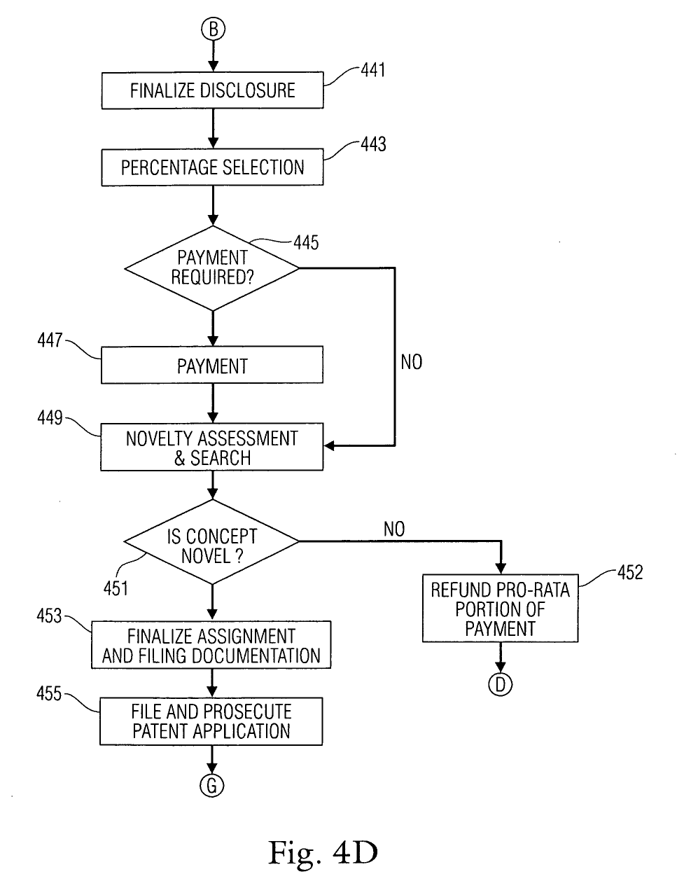

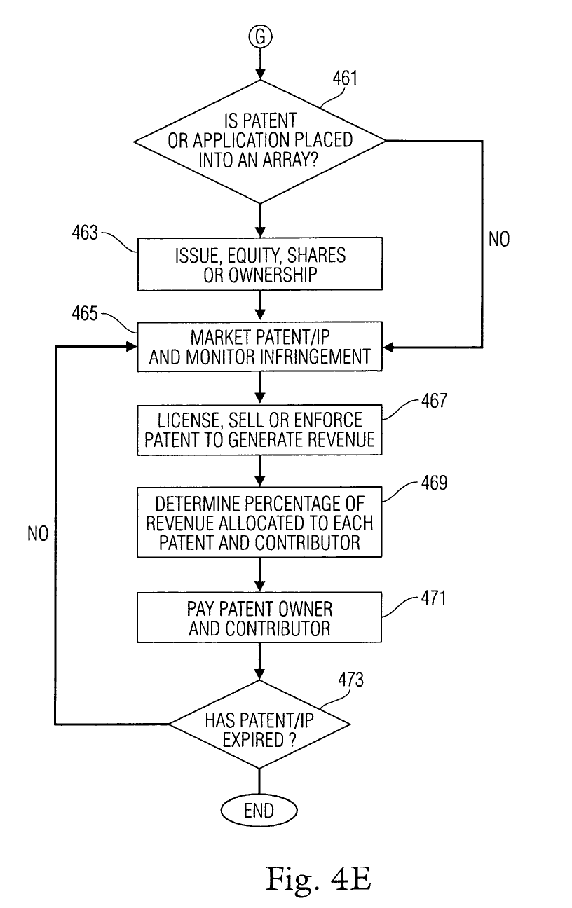

FIGS. 4A-4E provides a flow diagram of the users interaction with the hosted intellectual property collaboration network of the present invention. In the preferred embodiment, individual inventors and collaborators, inventors or project leaders associated with companies, university personnel or any other potential users who desire to create and/or collaborate on new or existing projects in the network would visit the website or IP address. The users would then register as a member of the network and enter their profile and attributes so that other members of the network could identify them for collaboration on projects and interact with the system. The following flow diagram helps illustrate the various steps, features, and functions available to users of the online, internet hosted or website based version of the present invention.

In step 401, a user starts travels to the home page or introduction page of the website. The user may have limited access or capabilities until they have registered and logged in. Therefore, for complete interaction and collaboration on the site the user must be a registered user of the site. In step 403, the user would enter their username and password for complete access. In the event the user is not a registered user hey could register as a member and enter their profiles (step 404) and (step 406) accept the user agreements and contracts necessary for interaction within the network or site and the structure around which the users agree to handle ownership and other related matters relating to the developed intellectual property. In step 404, the user would enter personal information such as name, address, and other contact information. The user would also enter any other information and attributes related to the user's potential contributions including: education, work experience, past projects, hobbies, existing patents or developments, or any other attributes which might be applicable for determining the users' capabilities and entice other users to seek his participation on identified projects. In step 406, the user would have to accept and agree to the contracts and user agreements required for participating on the site. In addition, step 406 might include a conflicts analysis which might determine if the user has any potential conflicts related to types of projects they would be restricted from submitting or collaborating on based upon their present employer's business.

Once the registered user has entered their name and password (Step 403) or registered as a new user (step 404) and accepted the contracts (step 406) they will be sent to main page of the website (step 405). The main page may be similar in appearance to the main page or homepage presented to the user in step 401. However, once the user has logged in (step 403) and been provided access they will have more complete access to all the features and functions of the site. As briefly discussed with regards to FIG. 3, those features and functions could include user registration, project administration and searching, technology needs, brainstorming sessions, user searching, technology information, network policies, network news, patent and array performance, network affiliated service provider information, and any other relevant information and features.

For exemplary purposes, the process flow will initially be discussed from the standpoint of a user that is establishing a new project. In step 407, the registered user could establish a new project. The new project might be based upon an idea or concept, a problem the user would like solved, improvements to an existing product or technology or any other project which would benefit from the network, collaboration with other members, or inclusion in the network patenting and marketing approach. Once the user has created the project they could determine if the project was a public or private project and establish appropriate password or protection levels. For a private project access to the materials would only be provided to those users that are collaborating on the project as accepted and approved by the project administrator. For public projects, the entire network could be provided access for any ideas which any member may have to add. For public projects, any significant contributions by members would require their inclusion as inventors. When establishing the project (step 407) the user would fill out an initial disclosure (step 409) and submit the disclosure/project through the system for a date stamp and inclusion in the project database (step 411).

Once the project is established in the network the user, now the project administrator determines if they need assistance (step 413). In the event that assistance is needed the project administrator can conduct a search of all registered users based upon the user's information and attributes to identify users which appear best suited to assist or collaborate on the project. The user search primarily entails text based or word searching for specific words related to the project, as defined by the project administrator, against the profiles and attributes of the registered user. The search could list the searched users in a ranked order by relevancy, by location, by a network rating based on positive activity in the network and with other members or other logical means establish by the search engine or the administrator conducting the search. Further, the users can establish different levels and types of activity or projects they are interested in so that their profile is ignored on searches for projects they do not wish to be involved in. Upon completion of the user search, the project administrator can filter, select and contact (step 417) the targeted users.

The project administrator can either identify the intended compensation for the users and/or negotiate the compensation each user might receive for collaboration or participation on the project. Once the users have been contacted they can accept, reject, or counter as to whether they are willing to collaborate on the project for the stated compensation. It is anticipated that the project administrator might want to select one or some minimal amount of potential collaborators or identify multiple users to establish a project team. Either way, the project administrator and users must ultimately establish the compensation, equity, or percentage of ownership of all project collaborators of the resulting IP (step 421). Once the compensation amongst the project administrator and collaborators is established, the project administrator and collaborating users can develop, improve, or refine the technology or project (step 423). At any point during the collaboration, the project administrator may, with or without approval of the other collaborators, seek further assistance by repeating steps 413-423. However, in the preferred embodiment, the project administrator could not alter the current collaborators ownership interests without their approval.

Once the project administrator and collaborators believe the development or improvement is finalized and needs no further assistance they can submit the project, development or improvement for review (step 410). Submission for project review would usually entail the project administrator and collaborators completing and submitting a more formal invention disclosure. The review, step 412, would then consist of various network participants or employees of the company running the network assessing the development from a novelty, marketing, and revenue potential standpoint as well the as a review of whether the patent should be included in one of the patent arrays within the network. In the preferred embodiment, the developments, improvements and technology advancements would be protected through issued patents and patent applications filed by the company running the network.

If the development is not approved, it will be determined whether the project might be accepted with further refinement (step 431). If the project or development might be approved with further refinement the project administrator and collaborators may continue to work on the project and repeat steps 413-423 for collaboration and repeat steps 410 and 412 for submission and review until approval. In the event it is determined (step 431) that the project or development does not warrant further refinement and that it will not be accepted the project is dropped (step 432) and the project terminates.

If the project or development is approved (step 412) for novelty and/or inclusion in one of the patent arrays within the network the project administrator and collaborators might update or verify that their invention disclosure is final (step 441). In step 443, the project administrator and collaborative users must make their brokerage percentage selection. In the preferred embodiment, the percentage selection is anticipated to provide the users multiple options for selecting the amount of money they wish to pay for patent, marketing, and licensing services in exchange a percentage or commission given to the network or company running the network for their patenting, marketing, licensing, and enforcement services. It is anticipated that various options would be available including free options or options which might allow third-party investors to pay for the patenting marketing services in exchange for a percentage of the potential royalties of the patent.

In the preferred embodiment, users might expect several choices. For example, the user might select to split all potential royalties on a 50-50 basis with the company providing the patenting, marketing, and licensing services for a one time fee. As an alternative, the user might select to retain 70 percent and grant the patenting, marketing, and licensing company 30 percent for a much higher fee. Further, it is anticipated that with appropriate cost efficiencies, the patenting, marketing, and licensing company might offer to accept cases for free in exchange for a high percentage of the patent (i.e. 90% of potential royalties).

In step 445, the system determines if payment is required based upon the user's selection in step 443 and, if payment is required, will require and processes payment in step 447 before progressing. The processing of payment in step 447 may be through multiple means known to those skilled in the art and would at least include the use of credit or debit cards, payments through network or other accounts, checks, or other common means used for payment of goods and services. Once payment has been received by the inventor, a third party investor or if payment is not required, the project is submitted for a final novelty search and assessment (see step 449). The novelty search and assessment (step 449) may or may not need to be conducted based upon any review done in step 412, may be in continuance of previous assessments, or fine tuning of the novel aspects. In step 451, the company running the network or other members of the network will determine if the disclosed development is novel and, therefore, likely to obtain a patent if filed. In the event that the concept is determined not to be novel and is denied, the project administrator, users, collaborators and/or investors would be provided a refund (step 452) of a pro-rata portion of the payment they made (step 447).

Provided the concept is determined to be novel, step 451, the process of preparing and filing the patent application begins. In steps 453 and 455 the patent application is prepared, all assignment documentation and patent filing documentation is completed, and the application is filed with the appropriate patent office. In the preferred embodiment, the company running the network would likely handle or manage the patent application preparation, filing, and all additional documentation required for the filing and full prosecution of the patent application.

Once the patent application is filed, or licensed, or soon after the patent application has been granted or issued the patent can be placed into a patent array (step 461). A patent array is essentially an IP portfolio which is focused in technology, yet contains the patents of numerous or different individual inventors, companies, universities, or others which may have an interest in the patents. In the preferred embodiment, it is anticipated that the patent arrays will have at least one patent and as many as several thousand patents related to a specific technology. Having the patents and/or patent applications grouped into technology focused arrays allows the company, or others, patenting, marketing and licensing the arrays to employ cost effective approaches and campaigns to maximize revenue form the patents in the array. The arrays or groups of patents within an array can be marketed and licensed more effectively to companies who are seeking to infuse their products with new innovations and technology or boost their own IP portfolio. It is further anticipated that by grouping the patents into arrays that compounded licensing opportunities will be available which allow licensees the ability to group various technologies or patents together for more robust products at reasonable licensing rates.

Another benefit of arrays is that it allows all patent owners or equity holders within the array to benefit from the acquired knowledge in a core technology, its corresponding market and the participants in the market. This combined knowledge allows the array participants to patent and market the portfolio in a more cost-effective manner thereby allowing all members to receive the cost benefits of volume patenting marketing. In addition, it is anticipated that some portion of all royalties flowing into the array will be shared equally (or some determined distribution) by all patents within the array. For example, if the array contained numerous patents and the array was structured such that 10% of all royalties received into the array would be shared equally amongst all patent holders in the array then all patents contributed into the array would reap some value or revenue even if a particular patent did not provide any revenue. Since the large patent array provided a benefit to the particular patents that were licensed sharing some percentage of revenue might be justified as a benefit for all those that participated and enhanced the licensing capabilities.

Assuming the patent or patent application is going to be placed into a patent array, the patent owners, contributors, investors, or others providing patenting or marketing services will be issued the appropriate amounts of shares, equity, or ownership in the patents as the patents or patent application are placed into the arrays. Further, it is anticipated that the arrays will either create shares or divide equity based upon contractual means or will establish separate entities (i.e. a limited liability company) and issue actual shares or equity in the company to the appropriate parties for the patents entering the array.

As an example of how the array distribution might work, a user establishes a project in step 407 and seek the assistance of one collaborator after searching the appropriate profiles in contact in the users as seen as steps for 413 through 423. The user who submitted the project is now the project administrator and agrees to give the collaborator 20% of their retained portion (step 421). After collaboration they submit the development for review and inclusion in an array step 410 and it is approved (step 412). In step 443, the project administrator and collaborator agree to a 70-30 split whereby they retain 70 percent of all royalties and 30 percent of all royalties would go to the patenting, marketing, and licensing provider. They agreed to have an investor fund a portion of their fees for a twenty percent stake and then make the required payment (step 447). The novelty search and assessment (step 449) provides the necessary information to indicate that the concept is novel (step 451) and the project proceeds to patent drafting and filing. The development is finalized and filed as a patent application in steps 453 and 455 and is now placed into an array (step 461) with appropriate shares issuing to the project administrator, the collaborator, the investor, and the patenting, marketing, and licensing company (step 463).

As an example, assuming the array has established that each new patent in the array will be issued 100, which is tallied against the total outstanding issue shares for all patents in the array, than the 100 will be divided amongst the participants. Since the selection was made for a 70-30 split in step 443 the patenting, marketing and licensing company would be granted 30 of the 100 shares for their 30% stake. The remaining 70 shares would be distributed amongst the project administrator, collaborator and investor based on a flat total percentage or a diluted percentage. If the members had negotiated a flat percentage than the collaborator would get 20 shares for their 20% stake, the investor would get 20 shares for their 20% stake and the project administrator would get the remaining thirty shares for their 30% stake. However, if the contributors use a diluted approach, then the investor would receive 20% of the retained 70 shares or 14 shares, the collaborator would receive 20% of the retained 70 shares or 14 shares, and the project administrator would receive the remaining 42 shares. The contributors and investors might also elect some combined straight or flat percentage mixed with a diluted percentage for certain contributors (i.e. the investor gets a flat 20% while the project administrator and collaborator use a diluted approach for remaining shares).

Once the patent is in the array, the array and all or some of its individual patents are marketed and monitored for licensing and infringement activities (step 465). Upon identification of an infringement or through proactive marketing and licensing the patents are licensed, sold are enforced to generate revenue. The revenue generated from the licensed and enforced patents flows back into the array. In the preferred embodiment, a portion of the royalty stemming from all of the patents would be shared equally amongst all patent holders in the array, while a distinct portion of revenue generated by a specific patent would go directly to the equity owners for that particular patent.

Continuing from our example above, if we assume that the patents in the array generated $1.0 million in total royalties for a given period and our particular patent generated a total of $200,000 in the same period, and that the array used a 10% revenue sharing model than all patent holders would evenly split 10% of 1.0 million or $100,000 dollars. Assuming there were 100 patents each patent would receive $1,000 dollars. Still further, since the one particular patent obtained $200,000 in licensing revenue it would receive a total of $181,000 which is the total derived after 10% is shared with the array and the $1,000 shared amount is added back. Continuing, now the $181,000 in revenue would be split amongst the shareholders for the particular patent. In our example using the flat percentage approach, the patenting, marketing, and licensing company would receive $54,300 or 30%, the investor would receive $36,200 or 20%, the collaborator would receive $36,200 or 20% and the project administrator would receive $54,300 or 30%.

The determination of percentage of revenue allocated to each patent and contributor is performed in step 469. In step 471 the project administrator, collaborators, investors, and other service providers involved in the process are paid based upon the established splits and calculated percentages. In step 473 it is determined if the patent or patents have has expired and if not the marketing monitoring, licensing, percentage distribution analysis, and payment steps (465-471) are repeated. Once the patent has expired, step 473, activities toward such patents ends.

The marketing (step 465), licensing (step 467), percentage calculation (step 469), and payment (step 471) could be performed for an array of patents of for an individual patent which was not placed into an array in step 461.

In the preferred embodiment, the system of the present invention includes means to reacquire or purchase back shares granted in the arrays or companies holding the arrays from those shareholders who had patents in the arrays which have expired thereby eliminating their benefit and contribution to the array. Such means might include contractual means to purchase back the shares for a predetermined minimal amount. By employing such measures, the arrays are allowed to continually add new and value adding patents while removing expired patents and the corresponding shareholders of such expired patents.

Section 3: An Exemplary System Architecture of the Invention

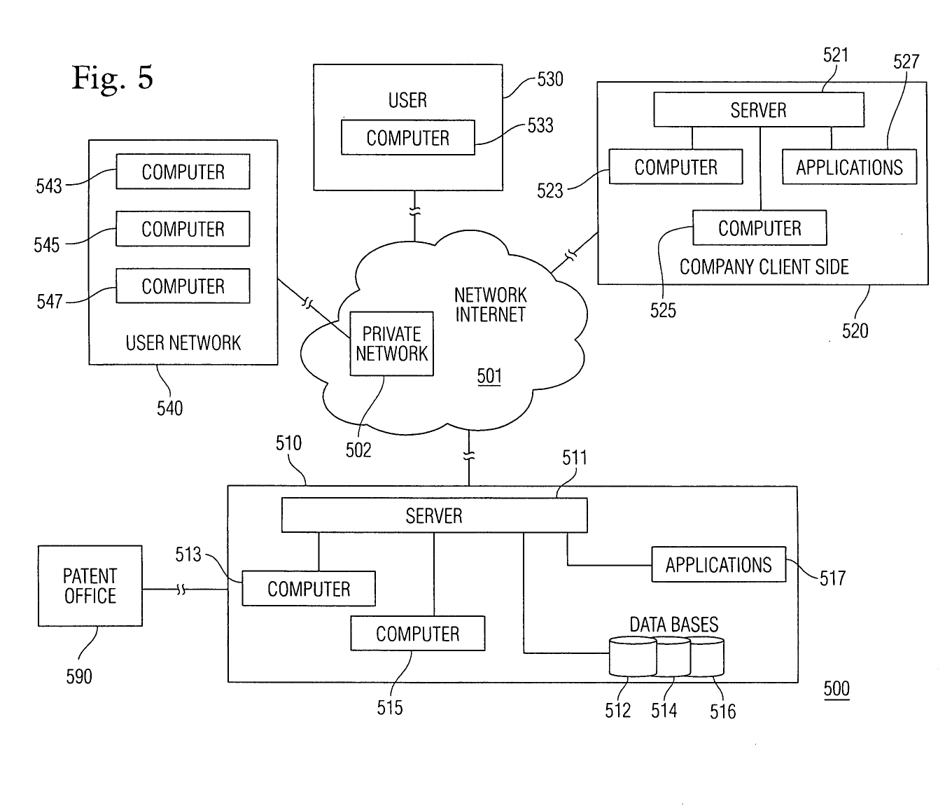

FIG. 5 provides a block diagram illustrating an exemplary computer or network architecture of the intellectual property collaboration network system 500 of the present invention. The system comprises a primary computer network system 510 which is comprised of a server 511 or multiple servers, which are connected to various computers or terminals 513, 515, application and accounting programs and means 517, and various databases 512, 514, 516. The primary network system 510 hosts the website it internet network 501. Through the internet network 501 access may be provided to various applications and data on the primary network system 510 to a host of internet network 510 members. These members could include: (1) individual users 530 connected through a user computer or terminal 533; (2) user networks 540 such as LANs, WANs, VPNs or the like which could be comprised of numerous computers or terminals 543, 545, 547 for each user in the user network 540; and (3) company or client side systems 520 which might be comprised of a company server 521 or multiple servers which are connected to various computers or terminals 523, 525 and various client applications such as accounting verification applications or secondary docketing applications or means 527. Further, the primary network system 510 would allow members 530, 540, 520 to create private networks 502 within the internet network 501. Such private networks 502 would enable those users of the system 500 who are working as teams to combine resources to more effectively collaborate and develop technology.

More specifically, a user 530 is connected through computer or terminal 533 to the primary network 510 through the internet 501. The user's terminal or computer 533 receives and delivers commands based upon specific interaction with the primary system or network 510 and displays it. The primary system or network 510 is comprised of various components including: (1) a server or multiple servers 511 for hosting the network 501; (2) various databases 512, 514, 516 for storing and retrieving relevant project, user, patent, market and accounting data; (3) application and accounting means 517 for running the various applications for running the network, access to the databases, and the calculation and accounting of the revenues and payments; and (4) various computers or terminals 513, 515 which may be associated with numerous applications, functions and/or users. The primary network or system 510 manages, runs, and hosts the internet hosted network 501, which allows users 530, user networks 540, and companies 520 through their terminals 523, 525, 533, 543, 545, 547, to interact and collaborate with one another and the applications and data available through primary system 510. The client system 520 is primarily intended to allow the employees of companies to interact with the site and collaborate on developments and projects with a large group of users 530, 540.

When a user 530 enters the site and initiates or collaborates on a given project through the intent network 501 they might interact with or be granted access to the various databases 512, 514, 516 based upon the various functions and application of the system 510. These application and function could include user search functions, project search functions, technology related searches, market or patent searches or any other relevant data the primary system 510 and its related components might provide.

Through the system 500 users 530 are able to identify additional users such as those within the user network 540 who are interested and technically capable of collaborating on a given project. The users 530, 540 might collaborate on a project and store all pertinent data and information related to the project within the databases 512, 514, 516 of the primary system 510 or might locally store such information on their computers or terminals 533, 543, 545, 547. Once the parties finalize their project and submit the disclosure on such project for approval and patenting through the network 510, establish the appropriate ownership interests of the users 530, 540 in the resulting patents the primary system 510 would store the relevant ownership data for use by the applications such as the accounting application or means 517 for determining royalty payments. The primary system 510 may be connected (via the internet to some other network) to a patent office 590 for processing the electronic filings of patent applications, or other patent related activities including payments.

The components of the intellectual property network system 500 and the primary system 510 might comprise typical server and CPU components for similar internet or network based systems. The present invention is not limited to the exact components and structure illustrated in FIG. 5 and the arrangement described herein is merely exemplary of typical internet or network based systems.

Section 4: An Exemplary Embodiment of the Invention

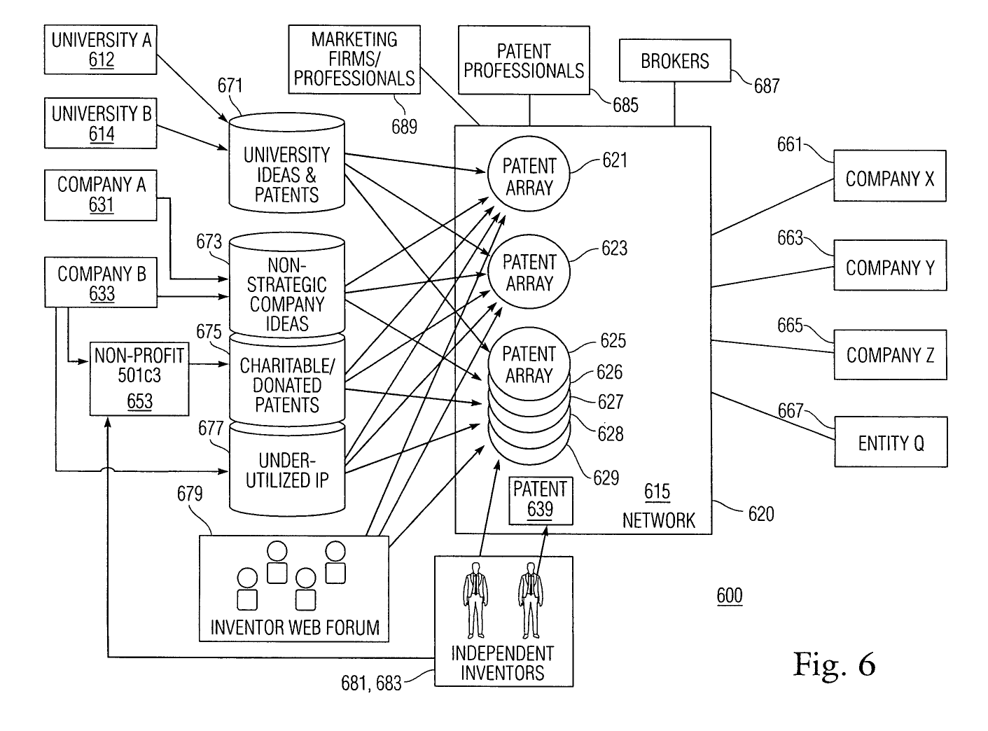

Another exemplary embodiment of the present invention will now be described in conjunction with FIG. 6. The present invention overcomes the obstacles and difficulties previously described above by providing a system which enables patent owners, inventors, companies, patent professionals, marketing professionals, brokers, and charitable organizations to utilize the intellectual property network 600 of the present invention to obtain patent volume and scale which create efficiencies to lower patent activity costs and increase revenue.

The intellectual property collaboration network system 600 depicted in FIG. 6 includes additional components to the intellectual property network 615 including: (1) university ideas and patents 671; (2) non-strategic company ideas (including strategic ideas that a company is willing to license) 673; (3) patents or intellectual property given as a charitable donation 675; (4) existing patents held by companies that the companies are willing to license; (5) existing patents and ideas held by independent inventors 681, 683; and (6) ideas and patents generated through the inventor or collaborative web forum 679.

Through the system 100, the various participants would submit their existing patents they are willing to license and/or submit their ideas for patenting and submission into the network 615. Universities 612, 614 would be able to submit their ideas and patents 671 which are not being fully utilized by their technology transfer programs and companies 631, 633 would be able to submit their ideas they want to patent and license 673 as well as their current and likely underutilized patents 677 they would like to license into the network 615. Further, Independent inventors 681, 683 would also be able to submit their patents and ideas for patenting into the network 615 as well as patents generated from the inventor web forum 679. Still further, both companies 631, 633 and individual inventors 681, 683 would be able to consider patent donations to non-profit charitable 501(c)3 organizations which can accept donations knowing the non-profit organization 653 will likely generate revenues by submitting the donated patents 675 into the network 615.

Ultimately, the combined ideas and patents of the participants 671, 673, 675, 677, 679, 681, 683 of the network 615 are then grouped together into logical technology related patent arrays 621, 623, 625m 626m 627, 628, 629 thereby creating enough technology focused patenting, marketing, and licensing activity to create efficiencies in scale to drastically reduce the related costs and while dramatically improving the licensing capabilities. The collaborative network system 600 and methods will improve patenting, marketing, licensing, and enforcement efforts as well as provide improved opportunities for those companies 661, 663, 665, 667 interested or forced to license or buy patents from the network 615.

Charitable Donation of Patents Within the Network of the Invention

Another aspect of the present invention depicted in FIG. 6 relates to patent donations and how they can be submitted and utilized within the network 615. As seen in FIG. 6, the intellectual property donation aspect of the system 600 of the present invention includes several components which include: (1) the patent network 615 which may be run or managed by a company or organization 620; (2) at least one charitable non-profit organization 653 for accepting donated patents and licensing the patents into the network 615, (3) individual users or inventors 681, 683 donating patents; (4) companies 631, 633 donating patents; (5) patents 639 or patent arrays or pools 621, 623, 625, 626, 627, 628, 629 within the network 615; and (6) companies, universities or other entities licensing or buying the patents 661, 663, 665, 667.

One of the most underutilized practices in the intellectual property life cycle is the donation of intellectual property, primarily patents, to charitable 501(c)3 organizations. Companies and independent inventors create and patent many ideas which may or may not be utilized by the patent owner. However, with the cost of maintaining patents, the inefficiency of most patent holders to effectively license their patents, and the fact that companies cease using their patents for various reasons the donation of patents is a viable alternative to abandonment. The donation provides the donor a tax deduction and any royalties or other proceeds derived from the donated patents will go to charitable organizations. Further, recent legislative changes related to patent donations has pushed patent donation towards a more accountable system which accounts for actual revenue received form the donated patents and provides a tax break back to the donor related to the percentage of royalties received by the charitable organization in future years.

However, most charitable organizations are not structured to handle patent donations, administer the transfer of the patents, maintain the patents, market the patents, negotiate license agreements, enforce patents, and administer any royalties. Therefore, one aspect of the present invention provides a non-profit charitable organization 653 (hereinafter “NPCO”) which can receive donated patents from companies 631, 633 and individual patent holders 681, 683. The NPCO 653 can then license the donated patents into or through the network 615 or include them in the patent arrays 621-629.

As an example of how the charitable patent donation aspect of the present invention is employed let assume Company B 633 and independent inventor 681 both have patents related to batteries or battery technology. Company B 633 and the independent inventor 681 have decided to donate their patents. Company B 633 has donated their patent to charitable organization 653. However, charitable organization 653 is not structured to market, license, or administer the donated patents and therefore utilizes the network 615 to reap revenue from the donated patents. In this example, the donated patent is placed within array 623 within the network 615. Further, independent inventor 681 has donated his patent to the NPCO 653.

The company 620 running the network 615 then places the donated patents into the appropriate array 623 and markets the battery technology array 623 to the various companies 661, 663, 665, 667. Company X 661 and Company Y 663 each pay royalties back to the company managing or running the Network 615 earmarked for array 623. The company 620 running the network 615 administers the proceeds from the patent array 623 back to the array participants according to the accounting methods previously described. The company 620 then reports and distributes proceeds from the corresponding donated patents in array 623 back to the NPCO 653 with a complimentary report to the donor 633, 683 for tax reporting purposes.

Although not depicted in FIG. 6, NPCO 653 could act as a central non-profit patent administrator for all other non-profits allowing companies and individuals donating patents to donate patents to the NPCO 653 yet designate a different non-profit charitable organization to receive the proceeds. The NPCO 653 would then distribute proceeds to the identified charitable organizations if not paid directly by the company 620 running the network 615.

The charitable patent donation aspect of system of the present invention provides a cost efficient method and process to reap value from donated intellectual property. An important aspect of the present invention is that the Network 615 is not limited to donated patents.

As further seen in FIG. 6, the Network 615 is also designed to allow companies 631, 633, universities 612, 614, independent inventors 681, 683, and inventors working through the inventor web forum 679 the ability to group their patents together into arrays 621, 623, 625, 626, 627, 628, 629 and benefit form the scale and volume of related patents which increase patenting, marketing, licensing and enforcement capabilities. Still further, the present invention allows companies 631, 633, universities 612, 614 and inventors 635, 637 to utilize the network to have the company 620 managing or running the Network 615 or other patent professionals 685 connected to the network 615 prepare and prosecute ideas into patents 639 and place the patents into arrays 621-629. Still further, the companies 631, 633, universities 612, 614 and inventors 681, 683 may work with other business professionals 689, law firms 685, licensing brokers 687, other companies 631, 633, universities 612, 614 and inventors 681, 683 and the inventor web forum 679 through the network 615 to assist in collaborating and developing inventions and technology and in the protection, marketing, licensing, and enforcement of such developments. It is anticipated that all members of the network 615 including the patent professionals 685, brokers 687, marketing or business professionals 689 will work for cash, equity in the patent arrays 621-629, equity in companies which may encompass, buy or license the arrays 621-629 or intellectual property, or any other reasonable compensation, or any combination thereof.

In addition, the company 620 managing the network may take a percentage of the revenue or proceeds from the licensed patents or charge a flat fee for managing and administering the network 615. Further, it is anticipated that if the company managing the Network 615 prepares and prosecutes, markets, licensing and enforces the patents from the companies, universities, or inventors that such services would be provided in exchange for cash or equity (or both) in the resulting patents or other intellectual property.

By way of example, Company B 633 has a patent which is donated to a non-profit charitable organization 653. The NPCO 653 may be a 501(c)(3) charitable organization (as defined by the Internal Revenue Service) or any other charitable organization which may legally receive the proceeds from a donated patent. The NPCO 653 then licenses the donated patent into the Network 615 which is then placed into array 623.

Company A 631 generates ideas and works through the network 615 to have the Patent Professionals 685 draft and prepare the patent application in exchange for an assignment of the patent into array 623 within the network 615 with the patent professionals 685 receiving a percentage of the ownership interest in the patent and therefore a percentage or shares in array 623. Further, independent inventors 681, 683 are co-owners and inventors of a patent which is assigned to array 623 for a percentage or shares in array 623. Equity, shares or ownership in and array may be granted through contractual means or a corporate entity may be formed to hold the assets of the array and actual shares or equity in the company could be distributed. In the this exemplary embodiment of the present invention the company 620 managing the network 615 would take an ownership or equity interest of any patents they prepared for the participants or patents they brokered, marketed, and/or enforced. Continuing with our example, then shares in array 623 would be distributed to the NPCO, Company A, independent inventors 681, 683, the patent professionals 685, and to company 620 patenting, marketing and licensing the patents and managing the network 615.

The arrays 621-629 or individual patents 639 within the network 615 or individual patents within the arrays 621-629 are licensed or sold to companies 661, 663, 665, or other entities 667 which pay a fee or royalty back to the company 620 managing the network 615 or to the particular array 621-629 within the network 615 and/or company holding the assets of the array. The royalties are then distributed to the appropriate parties (from our continued example above) including: (1) the NPCO 653; (2) Company A 631; (3) the patent professionals 685 for their efforts in conjunction with the patent for company A 631; (4) to the inventors 681, 683 for their co-owned patent, and to the company maintaining the network 615.

In addition, as briefly discussed above, the patent professionals (attorneys, agents, writers, etc.) 685, marketing and business professionals 689, licensing brokers 687 and other members of the network may be granted an equity interest in each array 621-629 for their contributions and/or collaboration on various projects which result in intellectual property or the licensing thereof through the network 615.

The system and methods of the present invention as described above enable individual inventors, companies, and universities to achieve the desirable large volume patenting, marketing, and licensing benefits and strategies implemented by some of the most successful intellectual property revenue generating companies even though individually they could not create such volume. The systems and methods of the present invention provide the required patent volume which decreases the cost to obtain, maintain and action against each patent thereby increasing the amount of patents which can be obtained further fortifying the networks formidable patent positions in technology areas resulting in increased licensing opportunities and revenue generation. The preferred embodiment of the present invention enables large companies, smaller companies, universities, and individual inventors to achieve desirable intellectual property licensing results typically only seen by the most successful and large companies through the intellectual property collaboration network of the present invention.

Although the invention has been described in detail above in connection with the various preferred and exemplary embodiments thereof, it will be appreciated by those skilled in the art that these embodiments have been provided solely for the purpose of illustration, and are in no way to be considered as limiting the invention or scope thereof. Instead, various modifications, substitutions, additions or deletions of equivalent systems, methods, and techniques will be readily apparent to those skilled in the art upon reading the specification, and such modifications, substitutions, additions or deletions are to be considered as falling within the scope and spirit of the following claims.

1. A method of compensating contributors who contribute on hosted projects comprising:
providing at least one server computer in communication with a computer network;
hosting at least one project for collaboration performed by said server;
providing information on said at least one project to a plurality of users in association with said server;
receiving a notification of a first contribution related to said at least one project from a first user and a second contribution related to said at least one project from a second user;
processing a compensation for said first user and said second user for said first contribution and said second contribution.

2. The method according to claim 1, wherein said at least one project is generated by at least one of said plurality of users in association with said server.

3. The method according to claim 1, wherein said at least one project for collaboration generates at least one patent.

4. The method according to claim 3, wherein said compensation is a percentage ownership interest in said at least one patent.

5. The method according to claim 4, wherein revenue generated from said at least one patent is distributed to said first user and said second user based upon said percentage ownership interest in said at least one patent.

6. The method according to claim 3, where said compensation is a percentage ownership interest of a patent array containing said at least one patent.

7. The method according to claim 6, wherein revenue generated from said at least one patent is distributed to said first user and said second user based upon said percentage ownership interest of said patent array.

8. The method according to claim 1, wherein said compensation is a monetary value.

9. The method according to claim 1, wherein said at least one of said first user and said second user were identified by searching a plurality of user information performed by or in association with said server.

10. A system for compensating contributors who contribute on hosted projects comprising:
at least one server computer hosting a collaboration network accessible via a computer network by at least one computer wherein said collaboration network includes at least one hosted project for collaboration;
a user interface provided by said at least one server which includes a project search object whereby a user interacts with said project search object to invoke a project search operation;
a first application for searching and displaying said at least one hosted project to said user based upon a search request;
a second application for enabling said user to submit a contribution;
a third application for processing a receipt notification of said contribution from said user; and
a fourth application for processing a compensation for said user for said contribution.

11. The system of claim 10, wherein at least one of said at least one hosted projects is generated by a second user through a second user interface provided by said at least one server.

12. The system of claim 10, wherein said at least one hosted projects generates at least one patent processed through said collaboration network.

13. The system of claim 12, wherein said compensation is a percentage ownership interest of said at least one patent.

14. The system of claim 12, wherein said compensation is a percentage ownership interest of a patent array which contains said at least one patent.

15. The system of claim 11, wherein a user profile search application for searching a set of profile date on a plurality of users is processed by or in association with said at least one server computer.

16. A method of collaborating on a hosted project comprising:
providing a web site hosted by at least one computer in communication with a computer network;
storing a set of information about a plurality of users performed by or in association with the web site;
hosting at least one project for collaboration generated by a first user performed by or in association with the web site;
providing information on said at least one project to said plurality of users performed by or in association with said web site;
searching said set of information about said plurality of users in response to a search request from said first user performed by or in association with said web site;
displaying a set of search results from said search request on a user interface performed by or in association with said web site;
processing a contact request from said first user to contact at least one selected user from said set of search results to collaborate on said at least one project by or in association with said web site; and
receiving notification of a first contribution from said first user and a second contribution from a second user for said at least one project.

17. The method according to claim 16, wherein said at least one project for collaboration generates at least one patent.

18. The method according to claim 17, which further includes the step of processing a compensation for said first user and said second user for said first contribution and said second contribution, wherein said compensation is a percentage ownership interest of said at least one patent.

19. The method according to claim 18, wherein revenue generated from said at least one patent is distributed to said first user and said second user based upon said percentage ownership interest of said at least one patent.

20. The method according to claim 17, which further includes the step of processing a compensation for said first user and said second user for said first contribution and said second contribution, wherein said compensation is a percentage ownership interest of a patent array containing said at least one patent.

21. The method according to claim 20, wherein revenue generated from said at least one patent is distributed to said first user and said second user based upon said percentage ownership interest of said patent array.
